(19) United States
(12) Patent Application Publication
(10) Pub. No.: US 2015/0115867 A1
(43) Pub. Date: Apr. 30, 2015

(54) SOLAR ENERGY HARVESTING PROTECTING SHEATH AND BACK-SIDE COVER FOR MOBILE DEVICE

(71) Applicants: YUN-SHAN CHANG, SAN JOSE, CA (US); DA-WEI LIN, New Taipei City (TW)

(72) Inventor: YUN-SHAN CHANG, SAN JOSE, CA (US)

(73) Assignees: DA-WEI LIN, New Taipei City (TW); YUN-SHAN CHANG, San Jose, CA (US)

(21) Appl. No.: 14/140,677

(22) Filed: Dec. 26, 2013

(30) Foreign Application Priority Data
Oct. 28, 2013 (TW) 102138883

(51) Int. Cl. H02J 7/35

(52) U.S. Cl. CPC H02J 7/355
USPC 320/101

(57) ABSTRACT

The present disclosure provides a solar energy harvesting protecting sheath for installing to the back-side cover of a mobile device. The solar energy harvesting protecting sheath comprises a body, a solar energy receiving unit, a solar energy harvesting circuit, a thermal resistive layer and an energy transmission interface. A containing portion of the body is for accommodating the mobile device. The solar energy harvesting circuit is disposed in the body and coupled to the solar energy receiving unit. The solar energy harvesting circuit has at least an energy storage unit for storing solar energy. The thermal resistive layer disposed in the body is placed between the solar energy receiving unit and the solar energy harvesting circuit. The energy transmission interface is coupled to the energy storage unit and transmits the energy in the energy storage unit to the mobile device through an electrical connector of the mobile device.

### BACKGROUND OF THE INVENTION

1. Field of the Invention

The instant disclosure relates to a solar energy harvesting device; in particular, to a solar energy harvesting protecting sheath and back-side cover for a mobile device.

2. Description of Related Art

Although solar energy harvesting is a feasible and reasonable energy source as compared to other existed candidates there are some other issues to be breakthrough to make it become a mighty energy source. The issues are solar cells efficiency and photo-voltaic energy harvest/transfer efficiency. III-V compound cell with new quantum dot technology shows amazing efficiency over 70% photo-voltaic conversion but it can be only used on special applications due to its extraordinary fabrication cost. Currently commercial solar cell is silicon based with about up to 21% photo-voltaic conversion efficiency. Even there are some other type solar cells, for example organic polymer and II-VI compound are announced, but the reliability, durability and cost make it is unable to be a suitable candidate. Latest most of solar cell manufactures invest more and more on the improvement of silicon-based solar cells with light intensity collection, incident light recycling, multiple-path absorption, etc. So far there is not a good photo-voltaic transfer design to accommodate the harvested solar energy transfer into stored voltaic energy and/or usable electric energy. Most of design need to be under high light incidence to trigger the harvesting energy transfer, for example more than 30-50K Lux. It is not suitable for mobile energy harvesting applications.

### SUMMARY OF THE INVENTION

The object of the instant disclosure is to provide a solar energy harvesting protecting sheath and back-side cover for a mobile device. The solar energy harvesting protecting sheath or back-side cover has a thermal resistive layer for avoiding the problem of over-temperature when the solar energy receiving unit is providing solar energy which would affect the normal operation of the mobile device.

In order to achieve the aforementioned objects, according to an embodiment of the instant disclosure, a solar energy harvesting protecting sheath is offered. The solar energy harvesting protecting sheath for a mobile device is for installing to a back-side cover of the mobile device. The solar energy harvesting protecting sheath comprises a body, a solar energy receiving unit, a solar energy harvesting circuit, a thermal resistive layer and an energy transmission interface. The body forms a containing portion for accommodating the mobile device. The solar energy receiving unit is disposed on the surface of the body. The solar energy harvesting circuit is disposed in the body and coupled to the solar energy receiving unit. The solar energy harvesting circuit has at least an energy storage unit, wherein the energy storage unit is for storing solar energy from the solar energy receiving unit. The thermal resistive layer is disposed in the body, and placed between the solar energy receiving unit and the solar energy harvesting circuit. The energy transmission interface is disposed on the surface of the body and coupled to the energy storage unit of the solar energy harvesting circuit, for connecting to an electrical connector of the mobile device, wherein the energy transmission interface transmits the energy in the energy storage unit to the mobile device through the electrical connector of the mobile device.

In order to achieve the aforementioned objects, according to an embodiment of the instant disclosure, a solar energy harvesting back-side cover is offered. The solar energy harvesting back-side cover for a mobile device is the back-side cover of the mobile device. The solar energy harvesting back-side cover comprises a body, a solar energy receiving unit, a solar energy harvesting circuit, a thermal resistive layer and an energy transmission interface. The body is for engaging with the mobile device. The solar energy receiving unit is disposed on the surface of the body. The solar energy harvesting circuit is disposed in the body and coupled to the solar energy receiving unit. The solar energy harvesting circuit has at least an energy storage unit, wherein the energy storage unit is for storing solar energy from the solar energy receiving unit. The thermal resistive layer is disposed in the body and placed between the solar energy receiving unit and the solar energy harvesting circuit. The energy transmission interface is disposed on the surface of the body and coupled to the energy storage unit of the solar energy harvesting circuit, for connecting to a battery of the mobile device, wherein the energy in the energy storage unit is transmitted to the battery of the mobile device through the energy transmission interface.

In summary, solar energy harvesting protecting sheath and back-side cover for the mobile device could convert solar energy to electricity and store the electricity. The electricity could be transmitted to the mobile device through the energy transmission interface.

In order to further the understanding regarding the instant disclosure, the following embodiments are provided along with illustrations to facilitate the disclosure of the instant disclosure.

### BRIEF DESCRIPTION OF THE DRAWINGS

FIG. 1A shows a cross-sectional view of a solar energy harvesting protecting sheath according to an embodiment of the instant disclosure;

FIG. 1B shows a schematic diagram of a solar energy harvesting protecting sheath according to an embodiment of the instant disclosure;

FIG. 1C shows a schematic diagram of an energy transmission interface of a solar energy harvesting protecting sheath according to an embodiment of the instant disclosure;

FIG. 1D shows a schematic diagram of a solar energy harvesting back-side cover according to an embodiment of the instant disclosure;

FIG. 2 shows a circuit diagram of a solar energy harvesting circuit of a solar energy harvesting protecting sheath according to an embodiment of the instant disclosure;

FIG. 3 shows a schematic diagram of the stacked structure of a solar energy harvesting protecting sheath according to an embodiment of the instant disclosure;

FIG. 4 shows a schematic diagram of the assembling process of a solar energy harvesting circuit according to an embodiment of the instant disclosure; and

FIG. 5 shows a circuit diagram of a solar energy harvesting circuit of a solar energy harvesting back-side cover according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment of a Solar Energy Harvesting Protecting Sheath for a Mobile Device]

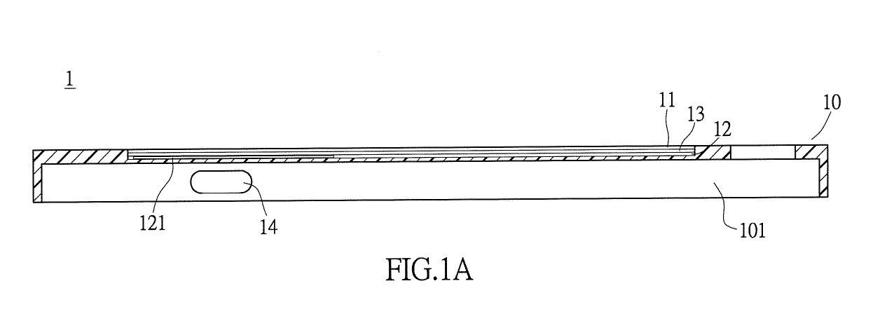

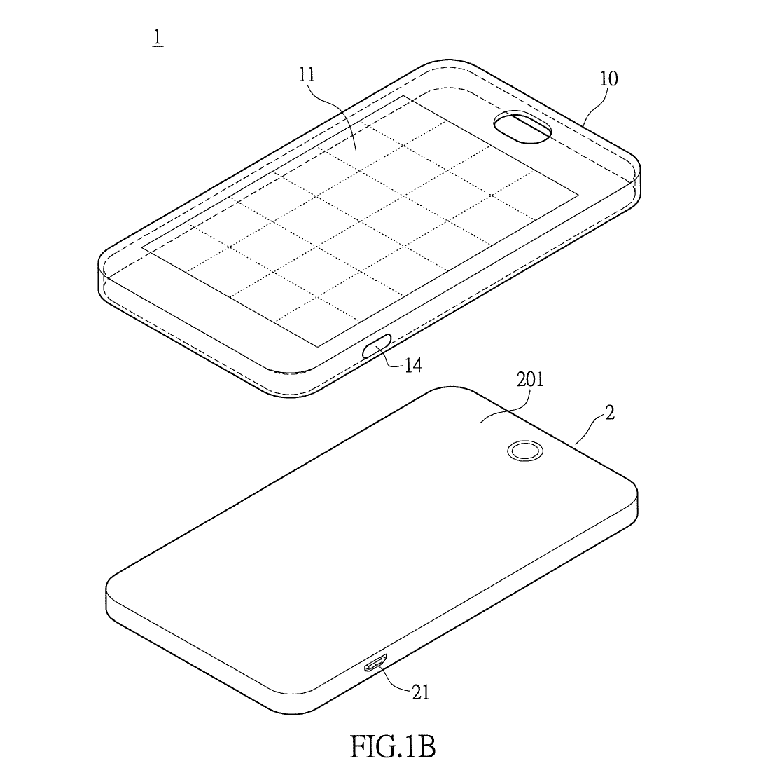

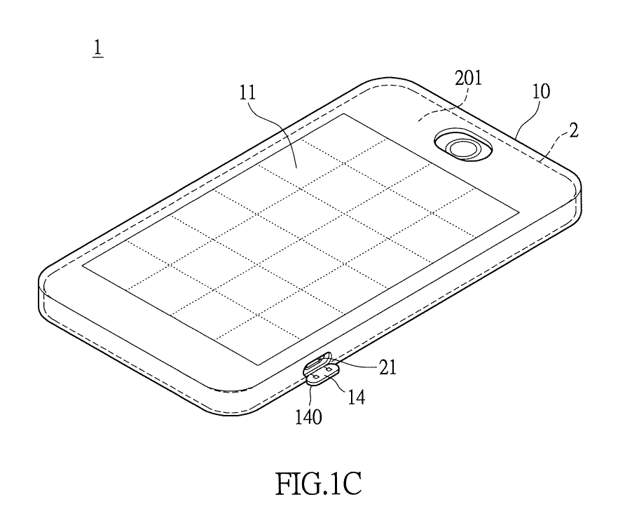

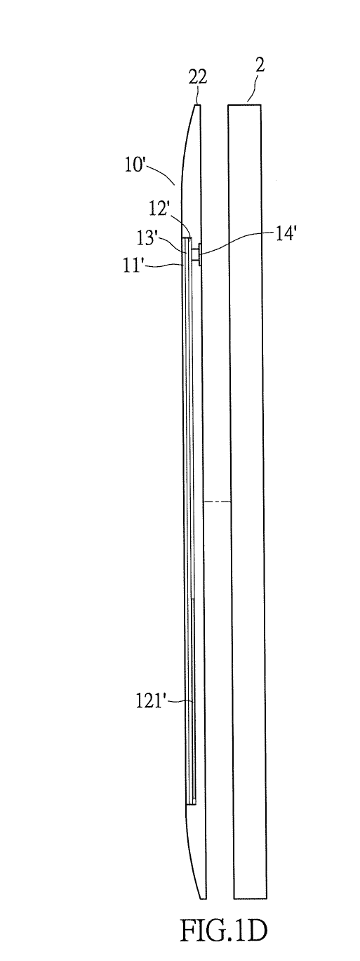

Please refer to FIG. 1A in conjunction with FIG. 1B. FIG. 1A shows a cross-sectional view of a solar energy harvesting protecting sheath according to an embodiment of the instant disclosure. FIG. 1B shows a schematic diagram of a solar energy harvesting protecting sheath according to an embodiment of the instant disclosure. A solar energy harvesting protecting sheath 1 for a mobile device 2 is for installing to a back-side cover 201 of the mobile device 2. The solar energy harvesting protecting sheath 1 comprises a body 10, a solar energy receiving unit 11, a solar energy harvesting circuit 12, a thermal resistive layer 13 and an energy transmission interface 14. The body 10 forms a containing portion 101. The containing portion 101 is for accommodating the mobile device 2. The body 10 is a protecting sheath of the mobile device 2. The body 10 may covers the back-side cover 201 of the mobile device 2, or the body 10 may covers the whole mobile device 2 while exposing the display or the buttons of the mobile device 2. The body 10 may be a plastic sleeve for example, or the body 10 may be made of other insulating material, but the instant disclosure is not so restricted. Engaging components could be designed on the body 10, thus the body 10 could be engaged to the back-side cover 201 or the casing of the mobile device 2.

The solar energy receiving unit 11 is disposed on the surface of the body 10. The solar energy receiving unit 11 usually is a solar panel having a plurality of solar cells. As shown in FIG. 1B, when the solar energy harvesting protecting sheath 1 is combined with the mobile device 2, the solar energy receiving unit 11 may be substantially parallel with the back-side cover 201 of the mobile device 2. However, this shouldn't be the limitation to the instant disclosure. As long as the solar energy receiving unit 11 could be exposed when the solar energy harvesting protecting sheath 1 is combined with the mobile device 2. The solar energy harvesting circuit 12 is disposed in the body 10 and coupled to the solar energy receiving unit 11.

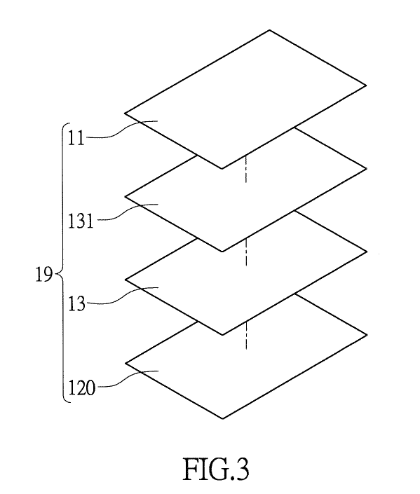

The solar energy harvesting circuit 12 has at least an energy storage unit 121, wherein the energy storage unit 121 is for storing solar energy from the solar energy receiving unit 11. The thermal resistive layer 13 is disposed in the body 10, and placed between the solar energy receiving unit 11 and the solar energy harvesting circuit 12. In other words, the thermal resistive layer 13 is for resisting heat which is generated when the solar energy receiving unit 11 is generating electricity, thus the temperature of the solar energy harvesting circuit 12 would not be increased. The thermal resistive layer 13 may be made of thermal resisting material, such as the asbestos cloth. However, the material of the thermal resistive layer 13 is not so restricted. The thermal resistive layer 13 could be attached to the solar energy receiving unit 11 with insulation glue. The insulation glue would not change its adhesion properties when the temperature goes high, thus the whole structure of the solar energy harvesting protecting sheath 1 could be stabilized. The manufacturing process and the structure of the solar energy harvesting protecting sheath 1 would be further described hereinafter (referring to FIG. 3).

The energy transmission interface 14 is disposed on the surface of the body 10 and coupled to the energy storage unit 121 of the solar energy harvesting circuit 12. The energy transmission interface 14 is for connecting to an electrical connector 21 of the mobile device 2, wherein the energy transmission interface 14 transmits the energy in the energy storage unit 121 to the mobile device 2 through the electrical connector 21 of the mobile device 2. The energy storage unit 121 and the battery 24 of the mobile device 2 are usually secondary batteries, such as lithium nickel batteries or lithium-ion batteries, but the instant disclosure is not restricted thereto.

Please refer to FIG. 1C showing a schematic diagram of an energy transmission interface of a solar energy harvesting protecting sheath according to an embodiment of the instant disclosure. In this embodiment, the energy transmission interface 14 has a flexible structure furnished on the body 10. The flexible structure is for engaging with the electrical connector 21 of the mobile device 2. As shown in FIG. 1C, the flexible structure 140 may be a soft structure having plastic or rubber. At least two flexible wirings are installed to the flexible structure 140 for connecting with the electrical connector 21 of the mobile device 2. When the user needs to use the solar energy harvesting protecting sheath 1 to charge the battery 24 of the mobile device 2, the user could manually engage the flexible structure 140 of the energy transmission interface 14 to the electrical connector 21 of the mobile device 2. Otherwise, the user could separate the flexible structure 140 of the energy transmission interface 14 from the electrical connector 21 of the mobile device 2. The operation of the solar energy harvesting circuit 12 is described in the following.

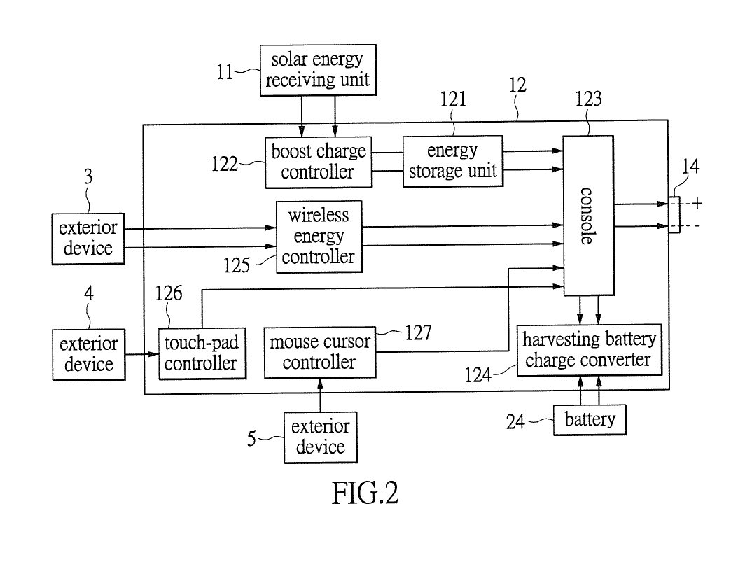

Please refer to FIG. 2 showing a circuit diagram of a solar energy harvesting circuit of a solar energy harvesting protecting sheath according to an embodiment of the instant disclosure. The solar energy harvesting circuit 12 comprises the energy storage unit 121, a boost charge controller 122, a console 123, a harvesting battery charge converter 124, a wireless energy controller 125, a touch-pad controller 126 and a mouse cursor controller 127.

The harvesting battery charge converter 124 is for coupling to the battery 24 of the mobile device 2. The console 123 is coupled to the energy storage unit 121, the energy transmission interface 14 and the harvesting battery charge converter 124, the wireless energy controller 125, the touch-pad controller 126 and the mouse cursor controller 127. The console 123 transmits the energy in the energy storage unit 121 to the energy transmission interface 14 or the harvesting battery charge converter 124.

The energy storage unit 121 receives the electricity of the solar energy receiving unit 11 through the boost charge controller 122. The console 123 manages the electricity transmission, and transmits the electricity of the energy storage unit 121 to the mobile device 2 through the energy transmission interface 14 or the harvesting battery charge converter 124. Specifically, when using the energy transmission interface 14 to transmit the electricity of the energy storage unit 121 to the battery 24 of the mobile device 2, the energy transmission interface 14 could be designed according to the type of the electrical connector 21 (e.g., charging connector or signal transmission connector) of the mobile device 2, thus the energy transmission interface 14 could be directly plugged into the electrical connector 21 of the mobile device 2. For example, the energy transmission interface 14 may be compiled with the interface of USB, Mini-USB, Micro-USB . . . etc.

On the other hand, if the design of the mobile device 2 could consider the structure of the solar energy harvesting protecting sheath 1, the mobile device may have a specific battery connector for coupling to the harvesting battery charge converter 124 of the solar energy harvesting circuit 12. Therefore, the battery 24 in the mobile device 2 could be charged directly through the harvesting battery charge converter 124. Meanwhile, the harvesting battery charge converter 124 may comprise a voltage converting unit for converting the voltage of the energy storage unit 121 close to (and larger than) the voltage of the battery 24 in the mobile device 2, and the mentioned voltage converting unit could controls the charging current. In other words, the harvesting battery charge converter 124 could replace the built-in charging circuit between the electrical connector 21 and the battery 24 in the mobile device 2. Because the solar energy harvesting protecting sheath 1 has the energy storage unit 121, the solar energy harvesting protecting sheath 1 can operate independently which includes storing solar energy and charging the battery 24 in the mobile device 2. Therefore, the solar energy harvesting protecting sheath 1 does not need to affect the internal circuit design and the normal operation of the mobile device 2.

The solar energy harvesting protecting sheath 1 of this embodiment could be designed with a variety of circuits for providing the flexibility in use. The console 123 manages the wireless energy controller 125, the touch-pad controller 126 and the mouse cursor controller 127. In other words, the solar energy harvesting protecting sheath 1 may comprises human machine interface sensors, such as the touch-pad controller 126 and the mouse cursor controller 127. The human machine interface sensor is coupled to the console 123. Each of the human machine interface sensor has a wireless module for wirelessly providing a control signal to an exterior device. For example, the wireless energy controller 125 enables the energy storage unit 121 of the solar energy harvesting protecting sheath 1 to be wirelessly charged. Usually, the wireless energy controller 125 comprises a coil which receives energy from the exterior device 3 through electromagnetic induction or electromagnetic resonance. The console 123 controls the wireless energy controller 125 to wirelessly receive energy. According to the controls of the console, the received energy of the wireless energy controller 125 could be stored to the energy storage unit 121 or transmitted to the battery 24 of the mobile device 2. Furthermore, the touch-pad controller 126 and the mouse cursor controller 127 (having the RF transmission circuits) both have the function of wireless transmission. The touch-pad controller 126 has a wireless module for wirelessly providing a control signal to an exterior device 4. In other words, the touch-pad controller 126 could act as a control terminal of a touch panel, in order to control the exterior device 4. The mouse cursor controller 127 has a wireless module for wirelessly providing a control signal to an exterior device 5. In other words, the mouse cursor controller 127 could control a cursor of the exterior device 5 (which is a computer) for controlling the exterior device 5. Accordingly, the solar energy harvesting protecting sheath 1 could act as a good human machine interface for wirelessly controlling exterior electronic devices.

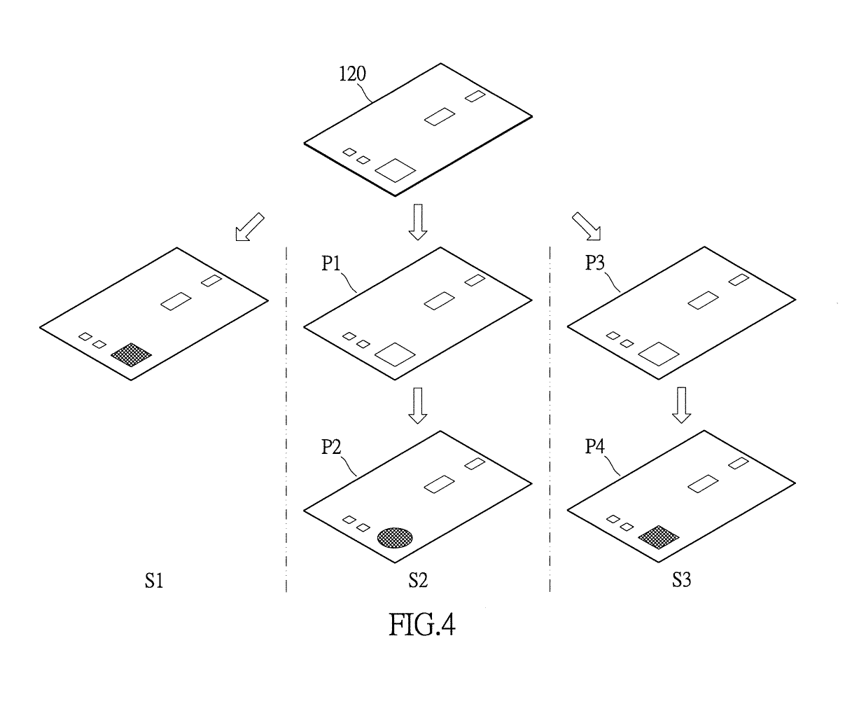

Please refer to FIG. 3 in conjunction with FIG. 4. FIG. 3 shows a schematic diagram of the stacked structure of a solar energy harvesting protecting sheath according to an embodiment of the instant disclosure. FIG. 4 shows a schematic diagram of the assembling process of a solar energy harvesting circuit according to an embodiment of the instant disclosure. In order to achieve the thermal insulation of the solar energy harvesting protecting sheath 1, a thermal resistive layer is essential to be made during the assembling process of the solar energy harvesting protecting sheath 1. The manufacturing process of the solar energy harvesting protecting sheath 1 comprises following steps. For the body 10, providing the body 10 (as shown in FIG. 1A), wherein the shape of the body 10 forms a containing portion 101 for accommodating the mobile device 2. For the solar energy receiving unit 11, the solar energy receiving unit 11 is disposed on the surface of the body 10 (as shown in FIG. 1A and FIG. 1B), in which the solar energy receiving unit 11 should be connected to the thermal resistive layer 13. Therefore, as shown in FIG. 3, the back of the solar energy receiving unit 11 is connected to the solar energy harvesting circuit 12 through the thermal resistive layer 13, thus the thermal resistive layer 13 is placed between the solar energy receiving unit 11 and the solar energy harvesting circuit 12. A thermal insulation glue 313 is utilized for bonding the thermal resistive layer 13 and the solar energy receiving unit 11. The solar energy harvesting circuit 12 is made on the circuit board 120, and the thermal resistive layer 13 is placed between the solar energy receiving unit 11 and circuit board 120. The circuit board 120 usually is a fiberglass substrate. In general, the storage temperature of the battery 24 of the mobile device 2 or the energy storage unit 121 of the solar energy harvesting protecting sheath 1 should close to the room temperature. Even during charging (or discharging), the temperature of the battery 24 or the energy storage unit 12 is usually lower than 60° C. The thermal resistive layer 13 insulates the thermal generated by the solar energy receiving unit 11 to prevent the temperature increase of the energy storage unit 121 or the battery 24 of the mobile device 2. In this embodiment, according to installation of the thermal resistive layer 13, the solar energy harvesting protecting sheath 1 could be designed as a thin structure whose volume is not large. Thus, the solar energy harvesting protecting sheath 1 could be easily integrated with the mobile device 2. Therefore, the volume of the solar energy harvesting protecting sheath 1 is quite similar to the volume of the conventional protecting sheath.

Accordingly, the solar energy receiving unit 11, the thermal resistive layer 13 and the circuit board 120 are laminated (or assembled) to form the module 19. The body 10 could be trenched or set up with a cavity for providing a space to accommodate the module 19. The module 19 could be installed in the body 10 as long as the solar energy receiving unit 11 could be exposed on the surface of the body 10.

For the manufacturing of the solar energy harvesting circuit 12, as shown in FIG. 4, three types of flow S1, S2 and S3 are provided. Flow S1: utilizing the surface-mount technology (SMT) to install all active components and passive components of the solar energy harvesting circuit 12 on the surface of the circuit board 120. That is, the solar energy harvesting circuit 12 could be made on the circuit board 120 by utilizing the surface-mount technology.

Flow S2: in phase P1, utilizing the surface-mount technology to install all passive components of the solar energy harvesting circuit 12 on the surface of the circuit board 120. Then, in phase P2, utilizing the chip size package (CSP) technology to install the chip made of the integrated circuit (IC) to the surface of the circuit board 120. In other words, according to the flow S2, at least one chip of the solar energy harvesting circuit 12 could be installed to the circuit board 120 by utilizing the CSP technology.

Flow S3: in phase P3, utilizing surface-mount technology to install all passive components of the solar energy harvesting circuit 12 on the surface of the circuit board 120. Then, in phase P4, utilizing the chip on board (COB) technology to install the chip to the surface of the circuit board. In other words, according to the flow S3, at least one chip of the solar energy harvesting circuit 12 could be installed to the circuit board 120 by utilizing the COB technology.

[An Embodiment of a Solar Energy Harvesting Back-Side Cover for a Mobile Device]

Please refer to FIG. 1D showing a schematic diagram of a solar energy harvesting back-side cover according to an embodiment of the instant disclosure. A solar energy harvesting back-side cover 22 for a mobile device 2 is the back-side cover of the mobile device 2. The solar energy harvesting back-side cover 22 comprises a body 10′, a solar energy receiving unit 11′, a solar energy harvesting circuit 12′, a thermal resistive layer 13′ and an energy transmission interface 14′. The body 10′ is for engaging with the mobile device 2. The body 10 of the solar energy harvesting protecting sheath 1 in the previous embodiment is redesigned to be the body 10′ of the solar energy harvesting back-side cover 22. Meanwhile, the solar energy harvesting back-side cover 22 and the mobile device 2 should be designed in coordination during the design process. The solar energy harvesting circuit 12′ is significantly identical to the solar energy harvesting circuit 12 shown in FIG. 2 except for differences specified in the follows. The energy transmission interface 14′ is designed as the electrical connector between the harvesting battery charge converter 124 and the battery 24. Please refer to following paragraphs about FIG. 3 for the details of the solar energy harvesting circuit 12′.

The solar energy receiving unit 11′ is disposed on the surface of the body 10′. The solar energy harvesting circuit 12′ is disposed in the body 10′ and coupled to the solar energy receiving unit 11′. The solar energy harvesting circuit 12′ has at least an energy storage unit 121′, wherein the energy storage unit 121′ is for storing solar energy from the solar energy receiving unit 11′. The thermal resistive layer 13′ is disposed in the body 10′ and placed between the solar energy receiving unit 11′ and the solar energy harvesting circuit 12′. The energy transmission interface 14′ is disposed on the surface of the body 10′ and coupled to the energy storage unit 121′ of the solar energy harvesting circuit 12′, for connecting to a battery 24 of the mobile device 2, wherein the energy in the energy storage unit 121′ is transmitted to the battery 24 of the mobile device 2 through the energy transmission interface 14′. Because the solar energy harvesting back-side cover 22 has the energy storage unit 121′, the solar energy harvesting back-side cover 22 can operate independently which includes storing solar energy and charging the battery 24 in the mobile device 2. Therefore, the solar energy harvesting back-side cover 22 does not need to affect the internal circuit design and the normal operation of the mobile device 2.

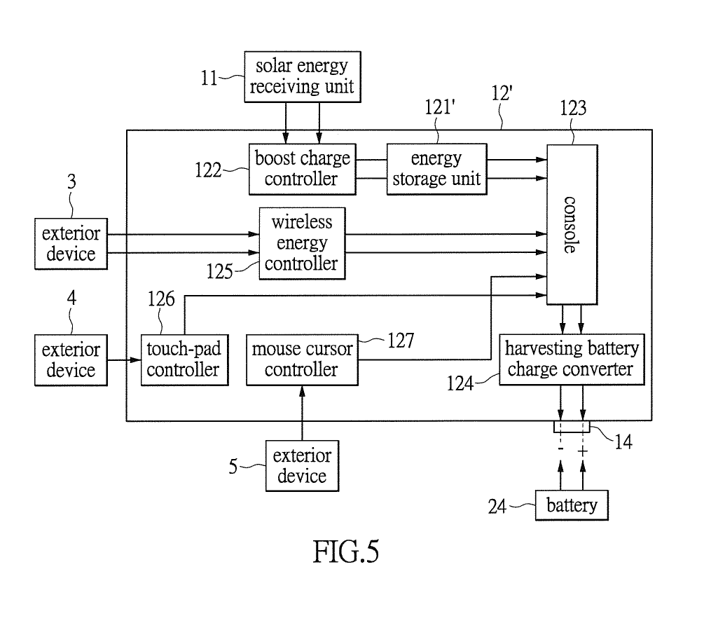

Please refer to FIG. 1D in conjunction with FIG. 5, the solar energy harvesting circuit 12′ may comprises the energy storage unit 121′, a boost charge controller 122, a console 123, a harvesting battery charge converter 124, a wireless energy controller 125 and the human machine interface sensors (which is a touch-pad controller 126 or a mouse cursor controller 127). The solar energy harvesting circuit 12′ is provided through changing the energy transmission interface 14 of the solar energy harvesting circuit 12 shown in FIG. 2 to the energy transmission interface 14′ for connecting to the battery 24 of the mobile device 2. In other words, the power output of the solar energy harvesting circuit 12′ for the battery 24 of the mobile device 2 is only through the energy transmission interface 14′. Furthermore, the console 123 is coupled to the energy storage unit 121 the harvesting battery charge converter 124, the wireless energy controller 125, the touch-pad controller 126, the mouse cursor controller 127 and the energy transmission interface 14′. The console 123 transmits the energy in the energy storage unit 121′ (through the harvesting battery charge converter 124) to the energy transmission interface 14′. Each of the human machine interface sensors (which are the touch-pad controller 126 and the mouse cursor controller 127) has a wireless module for wirelessly transmitting control signals to the exterior device 4 or the exterior 5. The manufacturing process for assembling the solar energy harvesting circuit 12′ and the solar energy harvesting back-side cover 22 is the same as the manufacturing process of the solar energy harvesting protecting sheath 1 in the previous embodiment, thus the redundant information is not repeated. For example, at least one chip of the solar energy harvesting circuit 12′ could be installed to the circuit board by utilizing the COB technology.

According to above descriptions, the solar energy harvesting protecting sheath or back-side cover has the thermal resistive layer for avoiding the problem of over-temperature when the solar energy receiving unit is providing solar energy which would affect the normal operation of the mobile device. The solar energy harvesting protecting sheath or the solar energy harvesting back-side cover could be designed as a thin structure whose volume is not large. Thus, the solar energy harvesting protecting sheath or the solar energy harvesting back-side cover could be easily integrated with the mobile device. And, the solar energy harvesting protecting sheath could be installed to the back-side cover of the mobile device. The solar energy harvesting protecting sheath could convert solar energy to electricity and store the electricity, and the solar energy harvesting protecting sheath could transmit electricity to the mobile device through the energy transmission interface. The solar energy harvesting back-side cover could be the back-side cover of the mobile device. In addition, the solar energy harvesting protecting sheath or the solar energy harvesting back-side cover could have additional functions such as wirelessly charging, human machine interface (e.g. a remote controller). Furthermore, with the function of solar energy charging, the solar energy harvesting protecting sheath can be used as the conventional protecting sheath. Also, with the function of solar energy charging, the solar energy harvesting back-side cover can be used as the conventional back-side cover of the mobile device.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A solar energy harvesting protecting sheath for a mobile device, for installing to a back-side cover of the mobile device, comprising:
a body, forming a containing portion for accommodating the mobile device;
a solar energy receiving unit, disposed on the surface of the body;
a solar energy harvesting circuit, disposed in the body, coupled to the solar energy receiving unit, having at least an energy storage unit, wherein the energy storage unit is for storing solar energy from the solar energy receiving unit;
a thermal resistive layer, disposed in the body, placed between the solar energy receiving unit and the solar energy harvesting circuit; and
an energy transmission interface, disposed on the surface of the body, coupled to the energy storage unit of the solar energy harvesting circuit, for connecting to an electrical connector of the mobile device, wherein the energy transmission interface transmits the energy in the energy storage unit to the mobile device through the electrical connector of the mobile device.

2. The solar energy harvesting protecting sheath according to claim 1, wherein the energy transmission interface has a flexible structure, the flexible structure is for engaging with the electrical connector of the mobile device.

3. The solar energy harvesting protecting sheath according to claim 1, wherein the solar energy harvesting circuit comprises:
a harvesting battery charge converter, for coupling to a battery of the mobile device; and
a console, coupled to the energy storage unit, the energy transmission interface and the harvesting battery charge converter, transmitting the energy in the energy storage unit to the energy transmission interface or the harvesting battery charge converter.

4. The solar energy harvesting protecting sheath according to claim 3, wherein the solar energy harvesting circuit further comprises:
a wireless energy controller, coupled to the console, wherein the console controls the wireless energy controller to wirelessly receive energy.

5. The solar energy harvesting protecting sheath according to claim 3, wherein the solar energy harvesting circuit further comprises:
a human machine interface sensor, coupled to the console, having a wireless module, for wirelessly providing a control signal to an exterior device.

6. The solar energy harvesting protecting sheath according to claim 1, wherein at least a chip of the solar energy harvesting circuit is installed to a circuit board through the chip on board (COB) technology.

7. A solar energy harvesting back-side cover for a mobile device, for being the back-side cover of the mobile device, comprising:
a body, for engaging with the mobile device;
a solar energy receiving unit, disposed on the surface of the body;
a solar energy harvesting circuit, disposed in the body, coupled to the solar energy receiving unit, having at least an energy storage unit, wherein the energy storage unit is for storing solar energy from the solar energy receiving unit;
a thermal resistive layer, disposed in the body, placed between the solar energy receiving unit and the solar energy harvesting circuit; and
an energy transmission interface, disposed on the surface of the body, coupled to the energy storage unit of the solar energy harvesting circuit, for connecting to a battery of the mobile device, wherein the energy in the energy storage unit is transmitted to the battery of the mobile device through the energy transmission interface.

8. The solar energy harvesting back-side cover according to claim 7, wherein the solar energy harvesting circuit comprises:
a console, coupled to the energy storage unit and the energy transmission interface, transmitting the energy of the energy storage unit to the energy transmission interface.

9. The solar energy harvesting back-side cover according to claim 7, wherein the solar energy harvesting circuit further comprises:
a human machine interface sensor, coupled to the console, having a wireless module, for wirelessly providing a control signal to an exterior device.

10. The solar energy harvesting back-side cover according to claim 7, wherein at least a chip of the solar energy harvesting circuit is installed to a circuit board through the chip on board (COB) technology.
